(19) United States
(12) Patent Application Publication
(10) Pub. No.: US 2004/0128903 A1
(43) Pub. Date: Jul. 8, 2004

(54) Mosquito barrier for drainage structure

(76) Inventor: Kenneth Wexler, Highland Park, IL (US)

Correspondence Address: Welsh & Katz, Ltd., Daniel M. Gurfinkel, 22nd Floor, 120 South Riverside Plaza, Chicago, IL, 60606, US

(21) Appl. No.: 10/338,386

(22) Filed: Jan. 8, 2003

(51) Int. Cl. A01M 1/10; A01M 1/20; A01M 5/00

(52) U.S. Cl. 43/122

(57) ABSTRACT

A mosquito barrier for use in catch basins and other water drainage structures is provided. The mosquito barrier is designed to prohibit an adult mosquito from penetrating the barrier, reaching standing water and laying eggs. Further, the mosquito barrier prohibits mosquitoes emerging from eggs laid downstream from emerging through a catch basin protected by the barrier of the present invention. The barrier is made with mesh of a size prohibitive to mosquito penetration while allowing water to flow through freely. The barrier rests within the catch basin, or other water drainage structure, well above the surface of standing water, such that all entering water must pass therethrough, and allows water to enter and flow through the structure with little flow restraint.

### FIELD OF THE INVENTION

The present invention concerns a novel mechanical barrier to prevent adult mosquitoes from entering catch basins, or other drainage structures, where they can breed or lay eggs in the standing water. The barrier would allow water to flow through to accommodate drainage while preventing adults or eggs from reaching water.

### BACKGROUND OF THE INVENTION

Mosquitoes are the carriers of several diseases, such as Malaria, West Nile Virus, and Dengue Fever that are associated with tropical climates. Historically, temperate climates have been immune from such diseases as a result of killing frosts and long hard winters having below freezing temperatures that have killed mosquitoes and mosquito larvae that carry such diseases. However, in 1999, West Nile Virus (WNV) was detected in New York City for the first time and within 3 years, the virus has spread quickly throughout most of the United States. The Chicago, Ill. area was severely affected in the summer of 2002, with over 40 deaths and 675 people reported to be infected.

Because of such results, it is now likely that such diseases, as WNV, have become capable of being indigenous to temperate climates, such as those of the central and eastern United States, and are here to stay. Further it is also likely that other serious mosquito-borne diseases which arrive in the United States by various means, could be left unchecked by current control measures, and could easily be transmitted throughout the entire United States once they arrive in the country.

There are many different species of mosquitoes, but the Culex mosquito is identified as the transmitter of the West Nile Virus. Mosquitoes mature through a life cycle called “complete metamorphosis”. Such a process involves four stages: egg, larva, pupa, and adult. Culex mosquitoes lay their eggs, such that they are linked together in rafts of 200 or more, on standing bodies of water. The eggs hatch into larvae within one to two days. The Culex larvae live in the water where their eggs were laid and come to the surface to breath and feed. The Culex larvae grow through a molting process. The larvae molt four times, growing larger each time, and changing into pupae after the fourth molt. The pupal stage is a resting, non-feeding stage. It usually takes about two days for the pupae to turn into an adult, split the pupal skin, and emerge. The adults rest on the surface of the water to allow their bodies to harden and wings to dry. The entire process takes about two weeks.

As is known by persons having skill in the art, mosquito management strategies encourage individual homeowners to be diligent, and eliminate breeding sites around the home by cleaning gutters, discarding old tires, and changing the water in birdbaths. However, just as on personal property, Municipalities have a responsibility to ensure that public land is clear of standing water that could serve as potential breeding habitats.

Municipalities are finding themselves unprepared to adequately control the mosquito populations. In many communities, current control measures allow for the mosquitoes to breed prior to their elimination by the community. Often communities use chemical approaches that fall under two main categories: one is Larviciding, an application to mosquito breeding grounds to kill larvae, and the other is adulticiding, the use of pesticides to kill adult mosquitoes.

In the summer of 2002, the City of Chicago targeted its catch basins for larviciding. A catch basin is a drainage structure that collects water runoff from a street or park, through a grate at ground level, and transfers the water to underground pipes. The catch basin also contains a sump, or a space in the structure's bottom that collects sediment and debris. This sump area is located below the outflow pipes, so any water that is captured there has no place to drain. This standing water is an ideal breeding habitat, with a high content of organic matter on which the mosquito larvae feed. These catch basins are typically located in the street, on almost every block, in urban areas.

Since any standing water is an opportunity for mosquitoes to breed, larvicides are applied to catch basins. Larvacides used in catch basins range from highly toxic organophosphates to bacteria and botanical oils. However, larvacides have many limitations. The less toxic bacterial products must be used once every seven days, and after every rain in order to effectively eliminate mosquito larvae. In addition, mosquitoes can develop resistance to the larvacides, making them ineffective. Finally, the catch basins usually drain directly into a body of water, such as a lake or river. The chemicals used in the catch basin are subsequently washed into the body of water and may cause environmental damage by killing aquatic life or polluting sources of drinking water.

Many municipalities also choose to use pesticides to kill adult mosquitoes, by using trucks or planes equipped for aerial spraying. Many municipalities had reduced or eliminated adulticiding over the past 20 years due to its high cost and its ineffectiveness. Adulticiding reduces, but does not eliminate the risk of mosquito-borne diseases. In addition, other animals and insects are affected by the spraying; some of these animals and insects are mosquito predators. As with any chemical pesticide, over time the mosquitoes develop a resistance that makes the chemical ineffective.

There are presently barrier means used in catch basins. However, existing barriers are used to collect sediment, including soils and garbage, typically drawn into catch basins as a result of rain runoff. These barriers have been found to be effective for erosion control and for keeping larger obstructive objects out of the storm sewer systems, but are not suitable for mosquito control. These barriers have been found to be ineffective for mosquito control as they typically have an overflow component, such as an opening in the device, which allows water to flow out during a heavy rain event, so as to prevent the catch basin from backing up. As a result, the drainage structure is not a closed system, and mosquitoes can still get in. Further, when such barriers trap sediment and garbage, the particles clog the bottom of the barrier causing the barrier to become less permeable. The less permeable barrier allows water to stand providing a breeding ground for mosquitoes thus completely defeating the purpose of having a mosquito barrier.

### SUMMARY OF THE INVENTION

In accordance with the present invention a mosquito barrier, for use in water drainage catch basins, is provided. The mosquito barrier comprises a basket having a support collar, the collar being engageable between the catch basin and its cover such that all water entering the catch basin enters the basket. In one embodiment of the present invention, the basket is cylindrical in shape and comprises a bottom, such that the basket fits within a catch basin having a cylindrical shape. In another embodiment, the basket is box shaped so that it can fit into a catch basin, or other drainage structure, having an opening which has a rectangular cross-section.

The basket of the present invention comprises walls made of a material having a plurality of openings for drainage of water. The openings, in a preferred embodiment of the present invention, are of a size through which an adult mosquitoes may not pass. In another embodiment of the present invention, a woven fabric or a mesh or net fabric, defining openings, though which an adult mosquito may not pass, is substituted for the material having a plurality of openings. In this manner construction of the basket may be simplified and costs reduced. The basket further comprises a structure including a frame holding the opening of the basket in an open position.

A preferred embodiment of such a device would consist of a cylinder with a collar lip. The sides and bottom of the cylinder would be made out of a perforated material, with a substantial amount of openings of a preferred dimension (1/16″) that would not allow an adult mosquito to pass through.

A typical catch basin is constructed out of concrete and is topped with a cast iron frame, with a frame lip, that holds the inlet grate at ground level. The device of the present invention would be inserted in the catch basin and would rest on the frame lip below the grate. The device of the present invention would thus be suspended above the interior pipes, so as to not inhibit water flow within the catch basin. This positioning of the device of the present invention in this location would prevent a mosquito from reaching the standing water typically found within the sump portion of the catch basin.

The preferred depth of the basket portion of the device of the present invention would allow a substantial amount of debris to collect at the bottom of the barrier while allowing water entering the barrier to still flow through the sides of the barrier.

The device of the present invention would preferably be placed into catch basins at the beginning of mosquito season, and could be left in place all year using a schedule for proper maintenance and cleaning practices, such as after the Autumn leaves have fallen. The device could also be placed into catch basins at the beginning of mosquito season and then removed at the end of mosquito season, typically at the time of a first strong killing frost.

The device of the present invention can be designed to fit into any catch-basin opening, having any cross-sectional shape, namely round, square or rectangular.

In a preferred embodiment, the frame lip of the barrier would be approximately 1/16 inch thick, so the catch basin grate would be raised only a minimal amount.

Further, the device of the present invention would protect against the emergence of mosquitoes, or their eggs, that have entered a drainage or storm water system at an unprotected point downstream and are subsequently flushed by the natural course of water to the area of a catch basin protected by a device of the present invention. The barrier device of the present invention would prevent any such mosquitoes from flying out of the catch basin and coming into contact with humans or animals.

A device made in accordance with the present invention can be constructed as either a rigid or flexible member. With respect to the rigid member, a preferred embodiment would include elements made of stainless steel using a welded construction. In a flexible construction, a manufactured bag made of a netting material with a stainless steel rim sewn into the hem of a net bag is preferred. Such a construction allows the device to be inserted into a catch basin of any depth and more specifically in a catch basin wherein there is an obstruction in the upper chamber of the catch basin, such as a pipe or some extraneous mortar that would prohibit the placement of a rigid basket.

### BRIEF DESCRIPTION OF THE DRAWINGS

FIG. 1 is a perspective view of a first embodiment of a device made in accordance with the present invention, showing the device in place in a typical catch basin.

FIG. 2 is another perspective view of the device of FIG. 1.

FIG. 3 is a partial cross-sectional view of the device of the present invention in place on a typical catch basin frame, taken along the plane of line 3-3 of FIG. 1.

FIG. 4 is a perspective view of another embodiment of a device made in accordance with the present invention.

FIG. 5 is a perspective view of another alternate embodiment of a device made in accordance with the present invention.

FIG. 5a is a perspective view of a grate for use with the device of FIG. 5.

FIG. 5b is a perspective view of another type of grate for use with the device of FIG. 5.

FIG. 6 is a perspective view of another embodiment of a device made in accordance with the present invention.

FIG. 7 is a perspective view of a detail of another embodiment of a device made in accordance with the present invention.

FIG. 8 is a perspective view of a detail of another embodiment of a device made in accordance with the present invention.

### DETAILED DESCRIPTION OF THE ILLUSTRATIVE EMBODIMENTS

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiments”) relates to a requirement of the United States Patent Office, and should not be found to limit the subject matter disclosed herein.

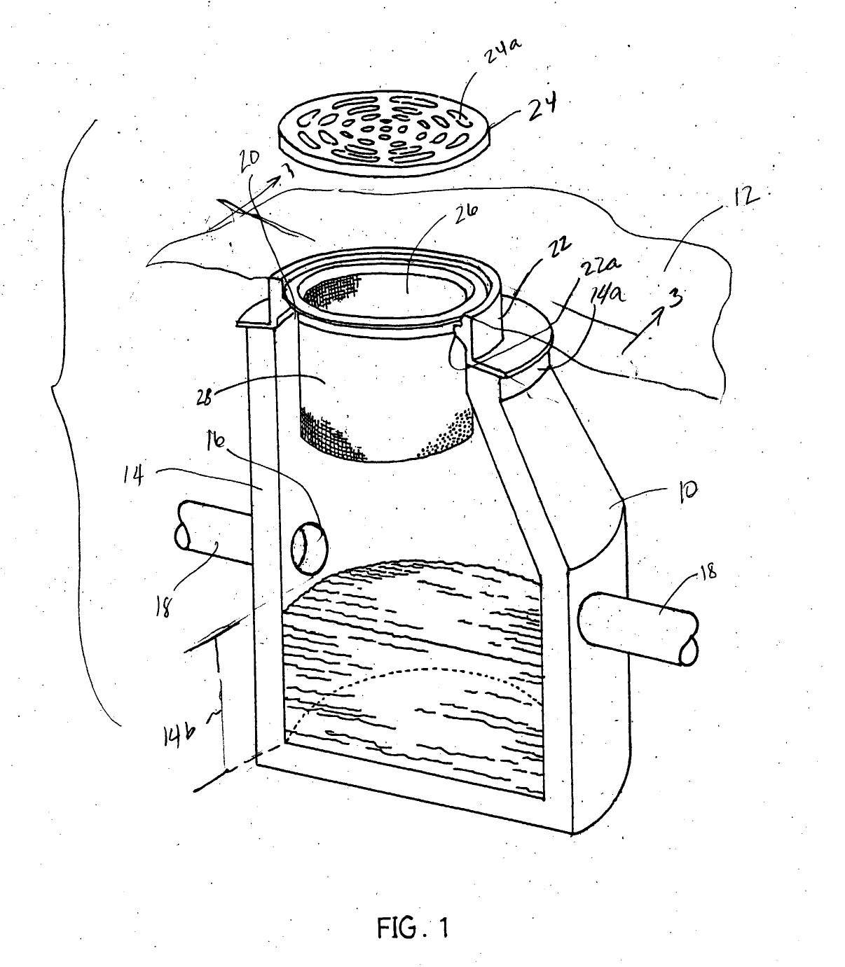

Referring to the drawings, a drainage structure mosquito barrier apparatus for use in the practice of the present invention is shown. Referring to FIG. 1, a typical catch basin structure 10 is shown in a typical configuration, having a majority of its body below ground 12. The catch basin structure 10 comprises a body 14, typically formed of concrete defining openings 16, into which drainage pipes 18 can be inserted or otherwise installed, and an opening 20, at its top 14a onto which a manhole opening structure 22 may be installed. As shown in FIG. 1, typical manhole opening structures 22 are constructed with a lip 22a onto which a manhole cover 24 may be placed to cover catch basin structure 10. It will be understood that various types of manhole covers 24 exist and may be used in combination with catch basins. In a preferred embodiment, manhole cover 24 is of the type that permits the drainage of water. As shown in FIG. 1, manhole cover 24 defines a number of openings 24a for water drainage. It will be understood by persons having skill in the art that manhole covers having any manner of drainage opening patterns may be used in association with the device of the present invention without departing from the novel scope of the present invention.

It will be seen, in FIG. 1, that catch basin 10 comprises a lower area 14b below the openings 16, where, due to its position below drainage pipes 18, standing water may collect.

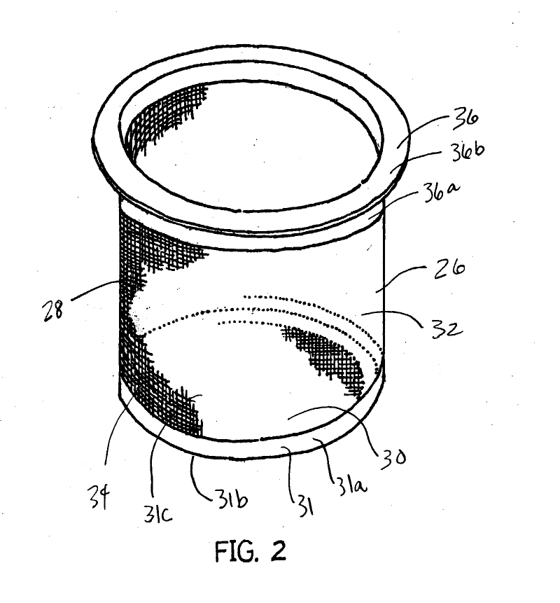

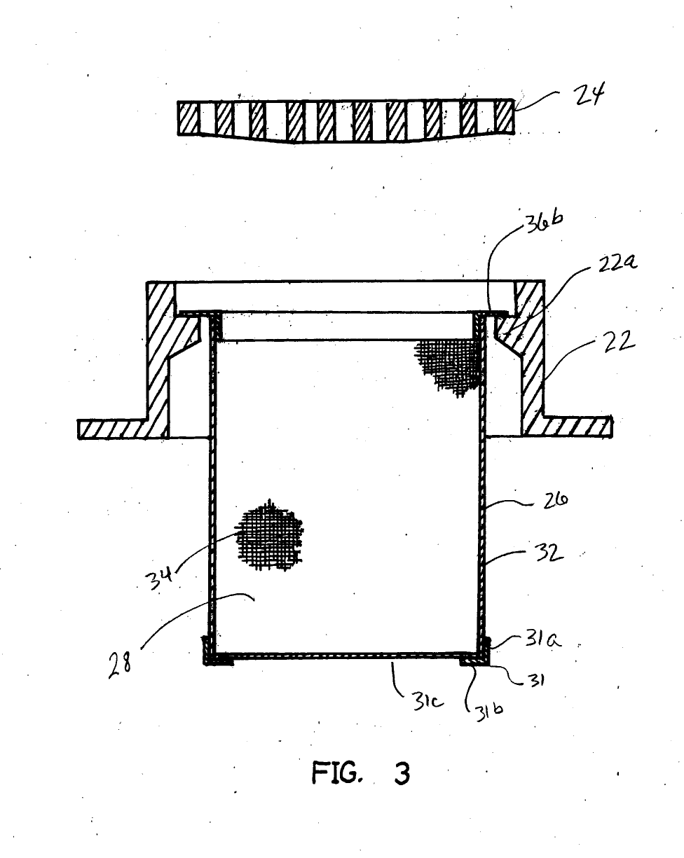

Within the structure shown in FIG. 1, a mosquito barrier 26 may be placed, as more clearly shown in FIG. 3. Mosquito barrier 26, shown in FIG. 2, comprises a generally cylindrical basket 28 having a bottom 30, comprising a support ring 31 having a generally vertical structural ring 31a and a support lip 31b for holding a mesh floor 31c formed of mesh 34. Basket 28 further comprises walls 32 comprised of a mesh 34. Materials suitable for the construction of mesh 34 will be described in more detail below. Mosquito barrier 26 further comprises a collar or attachment ring 36 comprising a generally vertical structural ring 36a and a lip 36b. Referring again to FIG. 3, it will be seen that lip 36b of basket 28 is placed onto lip 22a of manhole structure 22, prior to the placing of manhole cover 24 thereon.

It will be understood by persons having skill in the art that mesh 34 may be made of any suitable material which has such characteristics as durability and water permeability and resistance, as well as comprise a mesh fabric such neither mosquito adults cannot penetrate the mesh fabric, but water and air can.

In a preferred embodiment of the device of the present invention, the structural members or frame, including support ring 31 and its component parts vertical structural ring 31a, support lip 31b, and collar or attachment ring 36 and its component parts vertical structural ring 36a and lip 36b, all may be constructed of stainless steel. Stainless steel in the 300 series range, and preferably 304 may be used. While stainless steel is a preferred material in the construction of aspects of the device of the present invention (described above and below) it will be understood by persons having skill in the art, that any material capable of providing structural support and reinforcement, such as woods, plastics and other metals, may be used without departing from the novel scope of the present invention.

Attachment ring lip 36b, in a preferred embodiment may be constructed of steel having a range of thickness from 12-16 gauge, preferably 14 gauge. In a preferred embodiment of the present invention, mesh 34 is constructed of stainless steel having openings, such as perforations, of the same steel series and preference as indicated above for the structural elements of the frame. Mesh 34 preferably has a thickness in the range of 18-22 gauge steel, and most preferably of 20 gauge. In a preferred embodiment, the mesh 34 is created having openings have a range of size of between 0.046 (3/64) inches and 0.078 (5/64) inches, with a preferred opening size of 0.0625 (1/16) inches. In a preferred embodiment the openings are staggered at a distance of a range of between 1/16 inches and 1/8 inches, preferably having a distance of 3/32 inches between openings. It will be understood by persons having skill in the art that various modifications may be made and other materials may be used, including a variety of metal and plastic materials as well as the use of a wire and/or plastic mesh (for the mesh material used in mesh 34) without departing from the novel scope of the present invention.

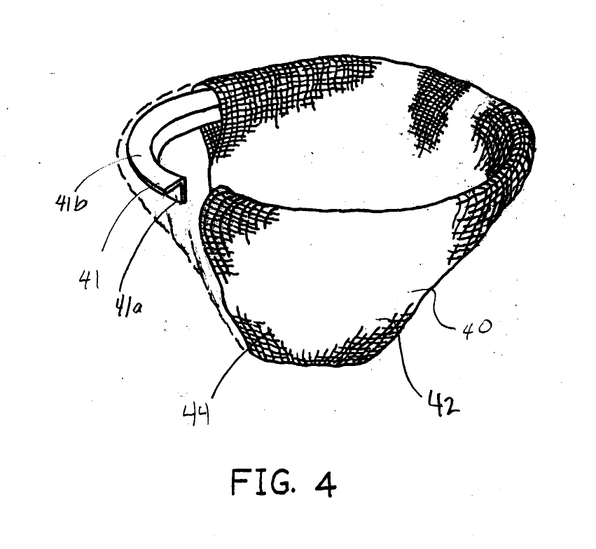

Referring to FIG. 4, another embodiment of the device of the present invention is shown. Mesh basket 40 comprises a support ring 41 having characteristics similar to those of support ring 31 shown in FIGS. 1 through 3. Support ring 41 comprises a structural ring 41a and a lip 41b. A mesh 44, comprised of a mesh fabric as described above, may be fitted about support ring 41. In a preferred embodiment ring 41 is entirely encompassed by the mesh 44, forming a bag 42. Bag 42 may be placed on a manhole cover 22, on lip 22a, in a manner similar to the manner to that shown for basket 26 in FIGS. 1 through 3.

In a preferred embodiment of the device of the embodiment, shown in FIG. 4, the structural members or frame, including collar or attachment ring 41 and its component parts vertical structural ring 41a and lip 41, all may be constructed of stainless steel, with the same range and preferences shown for ring 36 shown above. Mesh 44, in the embodiment shown in FIG. 4, is preferably constructed of a plastic-type material. In a preferred embodiment, mesh 44 is made of a polyester mesh with a poly-vinyl-chloride (PVC) coating having a total weight of about 7 to 10 ounces per square inch. In another embodiment mesh 44 is made of a heavy duty outdoor mesh fabric, such as a polyester mesh with a PVC coating, in other embodiments the mesh can be polypropylene or polyethylene knitted fabrics. In a preferred embodiment of the embodiment of FIG. 4, a mesh opening range similar to that expressed above for mesh 34, is used.

Preferably, all hems and seams, of the woven bag embodiment of FIG. 4, will be sewn together with moisture and ultraviolet light resistant synthetic thread, such as polyester or Dacron thread. It will be understood that hems and seams may also be fused or welded together. It will be understood by persons having skill in the art that various modifications may be made and other materials may be used, including a variety of plastic and metal materials as well as the use of a wire and/or plastic mesh (for the mesh material used in mesh 44) and that adhesives, of various types known to persons having skill in the art, may be used without departing from the novel scope of the present invention.

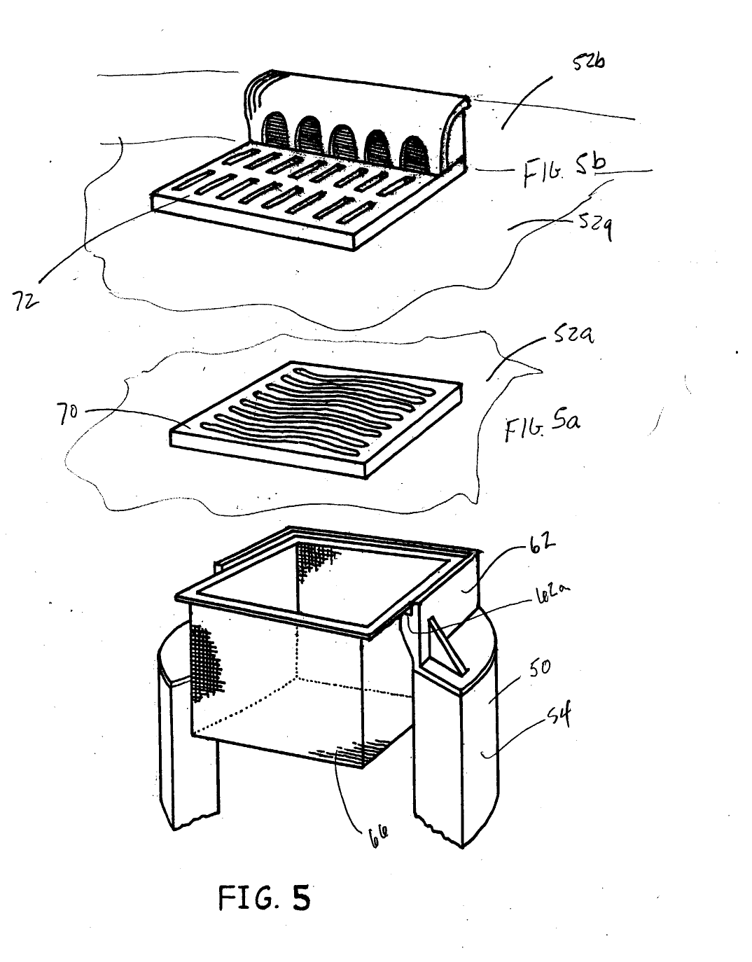

Referring now to FIG. 5, a variation of the drainage structure of FIG. 1 is shown. A catch basin 50 is shown having a configuration for use either in a road bed 52a or at a curb side 52b is shown. Catch basin 50 is shown in a typical configuration, having a majority of its body 54 below the surface of a road bed 52a. It will be understood that the body 54 of catch basin 50 is of a similar type as explained above with respect to FIG. 1, and that FIG. 5 shows only the upper part of the catch basin 50. As shown in FIG. 5, a drainage structure 62 is placed on or constructed with catch basin 50. Drainage structure 62 is constructed similarly to manhole opening 22 (FIG. 1) except that it is designed to facilitate its placement for enhanced drainage of rain water from streets. Typical drainage structures, such as structure 62, include a lip 62a onto which the cover can be placed.

It will be seen in FIG. 5 that a mosquito barrier 66, having a more square cross section than the mosquito barrier 26 shown in FIG. 1. It will be understood that the more square cross section is necessary to accommodate the shape of the opening in catch basin 50. It will be further understood, that while mosquito barrier 66 is made in a more square design, its operation and configuration are, in all other aspects, similar to the catch basin and mosquito barrier shown in FIG. 1. Further, it is within the scope of the present invention to use a flexible bag type mosquito barrier as shown in FIG. 4 and described above, in association with a square cross-section catch basin, or other drainage facility, without departing from the novel scope of the present invention.

As shown in FIGS. 5a and 5b covers 70 and 72, respectively, can be used in association with catch basin 50 when catch basin 50 is used, respectively in a street bed 52a (FIG. 5a) or a curb side 52b (FIG. 5b). The basic configurations of covers 70 and 72 are well known in the art and can be of a standard design.

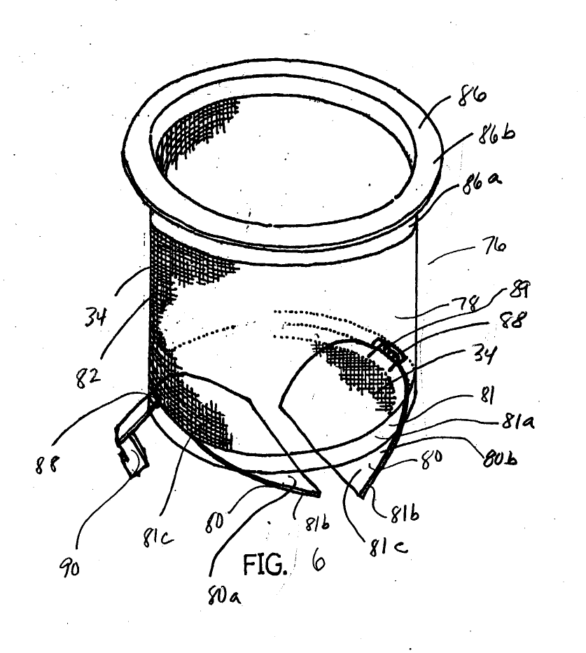

Referring now to FIG. 6, another embodiment of the mosquito barrier of FIG. 1 is shown. Mosquito barrier 76 is constructed in a manner similar to mosquito barrier 26 (FIG. 2) and comprises a generally cylindrical basket 78 having a bottom 80, comprising a support ring 81 having a generally vertical structural ring 81a and support lip parts 81b for holding a mesh floor 81c formed of mesh 34, of the type previously described. Basket 78 further comprises walls 82 comprised of a mesh 34. Mosquito barrier 76 further comprises a collar or attachment ring 86 comprising a generally vertical structural ring 86a and a lip 86b. It will be understood that lip 86b of basket 78 can be placed onto lip 22a of manhole structure 22 (FIG. 1), prior to the placing of manhole cover 24 (FIG. 1) thereon. It will be seen, FIG. 6, that barrier 76 includes the added benefit of having an openable bottom constructed of bottom portions 80a and 80b. Bottom portions 80a, 80b can be attached to support ring 81 using hinges 88. In a preferred embodiment, hinges 88 are spring loaded, using spring 89, so that bottom portions 80a and 80b can remain in a first closed (default) position until it is desired to open bottom 80 by separating portion 80a from 80b. In one embodiment, a counterweight 90 is attached to one or more of hinges 88 so that the bottom portions 80a, 80b tend to remain in a closed position until opening is desired.

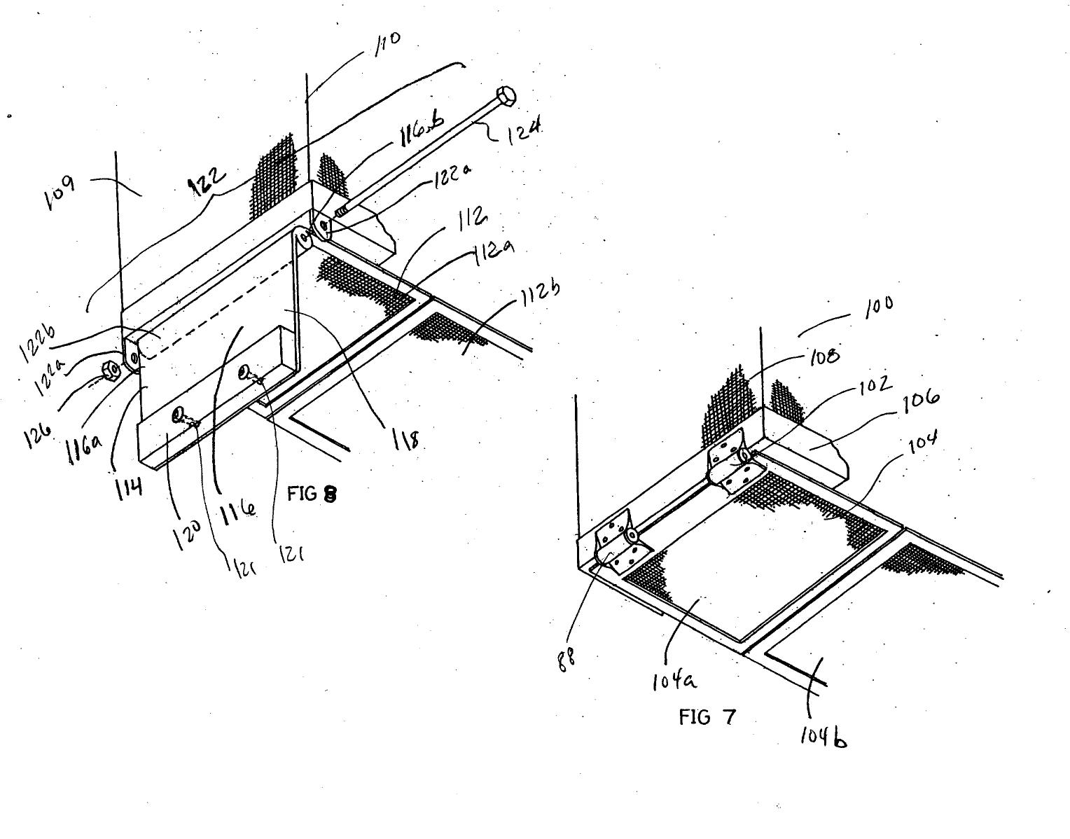

Referring to FIG. 7, a more detailed look at a hinged bottom mosquito barrier 100, similar to that shown in FIG. 6, is shown. In FIG. 7 adjustable tension spring hinge 102 are used to hold bottom 104 to frame 106 of a basket 108. Another type of mosquito barrier bottom opening system is shown in FIG. 8. Referring now to FIG. 8, a mosquito barrier 109 comprising a basket 110 is shown having a bottom 112 comprising two bottom sections 112a and 112b. It will be understood by persons having skill in the art that, if desired, bottom 112 can comprise a single door section, covering the entire bottom of the basket, without departing from the novel scope of the present invention.

In the present embodiment a square shaped basket 110 is shown, but it will be understood that any shape of basket, particularly those shapes discussed above, can be used without departing from the novel scope of the present invention. In the device of FIG. 8 a door unit 114, comprising a generally “L” shaped member 116 having legs 116a and 116b, is provided. Leg 116a comprises the bottom 112 of the basket 110 and leg 116b comprises a counterweight leg 118 carrying a counterweight 120 attached thereto. In a preferred embodiment, counterweight 116 is bolted to counter leg 114 using bolts 121, however, counterweight 114 maybe attached to leg 114 in any manner known in the art, including by rivets, adhesives, magnet, and others, without departing from the novel scope of the present invention.

Member 116, in the present embodiment, is attached to basket 110 using a hinge member 122 comprising hinge ears 122a and tube 122b. A bolt 124 and nut 126 rotationally connect basket 110 to “L” shaped member 116, so that when leg 116a is rotated away from basket 110, such that leg 116b rotates down and away from a first closed basket position, counterweight 120 will cause leg 116b to rotate back to the first closed position when leg 116b is released. It will be understood by persons having skill in the art that one or both parts of bottom 112 can be hinged or one of the parts of bottom 112 can be fixed without departing from the novel scope of the present invention.

In the use of the mosquito barrier 76 of FIG. 6, barrier 100 of FIG. 7 or barrier 109 of FIG. 8, after the basin is in use for a specified period, at collection of large particles of debris, and other materials, has occurred, barrier 76 (or 100 or 109) may be removed from the catch basin, bottom 80 (or 104 or 112) may be opened and debris easily removed. In this manner catch basins can be quickly serviced and mosquito barriers be cleaned and replaced into service. As an added benefit, specifically in the use of barriers (100 and 109) which include counterweights and spring mechanisms, such mechanisms can be designed so that when a specified weight of debris is reached the spring and/or counterweights may permit the bottom of the barrier to open, releasing the debris, and reseal, such that overflow of the basin (due to over collection of debris) is avoided while, almost continuously, preventing mosquito entry or exit.

In the use of mosquito barriers of the present invention, any one of the barriers shown and described, or those falling within the novel scope or equivalents of the present invention, can be placed within an existing catch basin. As water enters the catch basin it is allowed to enter into the lower regions and drain in the normal manner. As debris and other larger particles enter, they are trapped by mesh 34 (and the other mesh products described) such that they do not enter into the lower areas of the catch basin. In this manner the catch basin is maintained cleaner than present catch basins. As debris is collected in the barriers, water can still drain into the catch basin as the barriers provide permeable access for the water throughout the length of the barrier. It will be understood that cleaning of the barriers will be necessary, however, it is believed that such service will be in accordance with usual catch basin maintenance procedures and schedules. Advantageously, cleaning efforts will be lessened as catch basins will be kept cleaner as debris collects in the barriers. The placement of the barriers will generally simplify current maintenance procedures (as cleaning of catch basins will only require the removal of debris from the barrier rather than the cleaning of the entire catch basin).

Further, the presence of the mosquito barrier 26 (et al.) will keep adult mosquitoes from reaching the surface of the water within the catch basin, prohibiting their laying eggs in the water therein.

It will be understood by persons having skill in the art that the above noted mosquito barriers (26, 40, 66, 76, 100 and 109) can be easily incorporated into existing drainage structures with little or no reconfiguration or manipulation.

Although an illustrative embodiment of the invention has been shown and described, it is to be understood that various modifications and substitutions may be made by those skilled in the art without departing from the novel spirit and scope of the invention.

What is claimed:

1. A mosquito barrier, for use in water drainage catch basins, comprising:
a basket having a support collar, the collar being engageable between the catch basin and its cover such that all water entering the catch basin enters the basket;
the basket comprising walls having openings of a size through which an adult mosquito may not pass.

2. The mosquito barrier of claim 1, wherein the walls are constructed of a solid material into which openings have been formed.

3. The mosquito barrier of claim 1, wherein the walls are constructed of a mesh material.

4. The mosquito barrier of claim 1, wherein the basket is in the form of a cylinder and comprises a floor.

5. The mosquito barrier of claim 1, wherein the basket is in the form of a box, having walls and a floor

6. The mosquito barrier of claim 1, wherein the basket is constructed of a flexible material, the flexible material comprising openings.

7. The mosquito barrier of claim 1, wherein the basket comprises a structure including a frame holding the opening of the basket in an open position.

8. The mosquito barrier of claim 2 wherein the basket is constructed of steel.

9. The mosquito barrier of claim 3 wherein the basket is constructed of a plastic material.

10. The mosquito barrier of claim 9 wherein the plastic material is a polyester mesh having a poly-vinyl-chloride coating.

11. The mosquito barrier of claim 4 wherein the floor is hingedly attached to the walls such that the floor can be opened away from the basket to facilitate cleaning of the basket.

12. The mosquito barrier of claim 11 including a counterweight holding the floor in a first closed position such that when the floor is opened and released the floor returns to its first position.

13. A mosquito barrier, for use in water drainage catch basins, comprising:
a basket having a support collar, the collar being engageable between the catch basin and its cover such that all water entering the catch basin enters the basket;
the basket, being constructed of a flexible material, comprising walls defining openings of a size through which an adult mosquito may not pass, the walls forming a cylinder and the basket comprising a floor;
the floor being hingedly attached to the walls such that the floor can be opened away from the basket to facilitate cleaning of the basket.

14. The mosquito barrier of claim 13 wherein the material is a polyester woven mesh having a poly-vinyl-chloride coating.

15. The mosquito barrier of claim 13 including a counterweight holding the floor in a first closed position such that when the floor is opened and released the floor returns to its first position.
